(19) United States
(12) Patent Application Publication
(10) Pub. No.: US 2019/0383923 A1
(43) Pub. Date: Dec. 19, 2019

(54) Coordinated Searching Of An Airspace

(71) Applicant: Airbus Defence and Space GmbH, Taufkirchen (DE)

(72) Inventors: Fotios Katsilieris, Taufkirchen (DE); Bernhard Krach, Taufkirchen (DE)

(73) Assignee: Airbus Defence and Space GmbH, Taufkirchen (DE)

(21) Appl. No.: 16/437,309

(22) Filed: Jun. 11, 2019

(30) Foreign Application Priority Data
Jun. 13, 2018 (DE) 10 2018 114 109.2

(51) Int. Cl. G01S 13/04; F41G 7/22; G01S 13/87

(52) U.S. Cl. CPC G01S 13/04; G01S 13/87; F41G 7/2286; F41G 7/2253

(57) ABSTRACT

A method for searching a search area, with a missile and with a missile formation is described Based on the method, in each case at least one radar is arranged in at least two missiles, wherein the method includes: splitting the search area into at least two search subareas, searching the at least two search subareas by the respective radar of the at least two missiles, wherein the at least two missiles carry out the searching cooperatively, wherein the search subareas are chosen such that a total search time is minimal.

### FIELD OF THE INVENTION

The present invention is concerned with a method for searching a search area, with a missile and with a missile formation.

### BACKGROUND OF THE INVENTION

Modern aircraft are for the most part equipped with a large number of sensors that have an important role for the aircraft and/or for the pilot in order to carry out a mission with the best possible outcome.

One such sensor is a radar, for example, which is also one of the most used sensors for position image recognition. A radar can be used to identify or detect objects or targets at long ranges. The properties of a radar are less affected by the weather than a camera sensor, for example. Target detection/tracking by means of radar is for example still possible even when it is no longer possible with imaging electro-optical or infrared sensors on account of IMC (Instrument Meteorological Conditions).

Aircraft are often equipped with mechanically swivelling radar antennas. The result of this is that the searching of an airspace could be carried out using a pair of parameters, which would be optimizable. Usually, the pilot defines the airspace that is supposed to be searched, for the most part as an angle statement and a half-width, and the range within which a target of defined size is supposed to be detected. On the basis of this information, the radar optimizes the waveform that is then transmitted. With such an approach, the search pattern and the scanning of the airspace are stipulated to the greatest possible extent and are dependent only on the size of the airspace that is being searched.

### BRIEF SUMMARY OF THE INVENTION

Aspects of the present invention may improve the searching of an airspace such that fast and efficient position image recognition, for example for a pilot, can be ensured.

According to an aspect of the invention, a method for searching a search area is specified, wherein in each case at least one radar is arranged in at least two missiles. The method comprises: a) splitting the search area into at least two search subareas, b) searching the at least two search subareas by means of the respective radar of the at least two missiles, wherein the at least two missiles carry out the searching cooperatively, wherein the search subareas are chosen such that a total search time is minimal.

A radar is configured to detect various objects. In particular, the radar can perform the searching of a search area, which for the most part is a (air) volume. According to an aspect of the invention, a search area will be searched such that objects or targets can be detected with the prescribed, selectable or adjustable detection probability. In other words, the probability of, after the search area is searched, there being undetected targets or objects in said search area is very low; as few as possible or no targets or objects remain undetected. The searching is of the greatest importance for the position image recognition by a pilot, for example. Undetected objects or targets can become a problem not only on account of potential hostility during a mission, but also on account of a possible risk of collision in the airspace. Position image recognition denotes the determination of the location or speed of other targets or objects.

Radar sensors, also called radar for short herein, are sensors that the missile has, possibly besides further sensors such as a camera, etc. Such a radar may be equipped with active electronic actuation of the individual elements of the radar (active electronically scanned array antennas (AESA)). Such a radar can steer the radar beam almost instantaneously for different solid angles (a solid angle is specified as horizontal and vertical angles, also called azimuth and elevation), so that adaptive beam orientation is possible.

A missile comprises any type of flying device having any type of propulsion. By way of example, aircraft, unmanned aircraft, known as UAVs (unmanned aerial vehicle), drones, guided missiles, rockets or helicopters.

The search effort for detecting an object or target in the search area by means of two or more missiles is performed cooperatively. That is to say that coordinated searching of the search area takes place.

The search area is a (air) volume that can be covered by the at least one radar of the respective missile. The search area can be specified on the basis of horizontal and vertical angles. It is also possible to specify the search area on the basis of three-dimensional coordinates.

Often, the missiles are in a flight formation in the airspace flown through. The search area will be in the surroundings of both missiles, for example. Preferably, the search area will be in front of the missiles, as seen in the direction of flight.

The area to be searched in the airspace, that is to say in the search area for the missiles, is split into at least two search subareas. In some examples of the invention, the number of search subareas corresponds to the number of missiles. The at least two search subareas are searched by the respective radar of the missile, wherein in each case one missile searches at least one search subarea.

The searching of the search subareas or of the search area is cooperative searching. The search effort is distributed such that the same areas of the search area do not have to be searched more often. In the case of two missiles having one radar each, the search area is split into two search subareas, for example. The two missiles examine their respective search subarea at the same time or substantially at the same time. In some examples, the method is performed by at least two missiles that are in the air.

The search subareas are chosen such that a total search time is minimal. This ensures that the best split of a search area is found and that repeated searching of the same area is not performed. The search area is searched in the fastest possible time, so that a time saving for searching a three-dimensional air volume, which can also be described by the pilot, is achieved. The method according to the invention allows delays when searching a search area to be avoided that occur for example when the search area is split in a naïve manner, for example into equal shares. This applies in particular if the search area extends at arbitrary horizontal and vertical angles in the airspace. In some examples of the method, the total search time is the cooperative total search time needed by the at least two missiles in order to search the search area.

According to one example, the total search time is the maximum from the search times for the applicable search subareas. By way of example, the search times can be measured for different splits of the search area into search subareas, and in this way the maximum of the search times can be determined. For one particular split of the search area into search subareas, the total search time is minimal. The search time is the time that the radar beam needs in order to illuminate the search subarea and to receive the echo. In some examples, the time needed to process the received signal (echo) in order to spot objects or targets is also taken into consideration.

According to one example, the probability of detection of an object in the search area is prescribable or predefined. By way of example, the pilot can prescribe the probability of detection. If need be, the probability can be changed or matched to the respective position image recognition.

According to one example, the search subareas have substantially no overlap. In some examples, the search subareas have no overlap. As a result, the coordination of the searching becomes simpler and the communication requirement between the missiles is low. There are examples in which the search subareas overlap minimally. A minimal or non-existent overlap avoids repeated searching of a (sub)area, and the search effort for searching a search area can be kept down. Gaps in the search area are also avoided, while at the same time the total search time is minimal.

According to one example, the search area is prescribable or alterable. By way of example, the pilot can prescribe the search area by setting a horizontal or vertical angle and the associated (half-)width (also referred to as (half-)width in azimuth and elevation). If need be, the search area can be matched to the respective position image recognition. In some examples, the search area is predefined.

According to one example, the splitting of the search area into search subareas changes according to the movement and/or the trajectory of the at least two missiles.

According to one example, the splitting of the search area into search subareas is continually adapted according to the movement and/or the trajectory of the at least two missiles. The search area is prescribed by means of three-dimensional coordinates, for example. The missiles move in the search area, which means that the horizontal and vertical angles (angles of azimuth and elevation) and the angle widths thereof change.

According to one example, a minimal probability of detection of an object of the prescribed size at a prescribed distance is ensured. This is used for situational attentiveness, so that for example it can be specified for the pilot how well the search area has been searched.

According to one example, a search subarea is determined based on a horizontal angle, a vertical angle and associated angle widths, or based on three-dimensional coordinates. It is also possible for all search subareas to be determined on the basis of horizontal angle, vertical angle. In some examples, it is possible for the one or more search subareas to be determined by means of three-dimensional coordinates, for example the corners or the surfaces of the search subarea are specified.

According to one example, one of the at least two missiles assigns the search subarea to be searched to the at least one other missile. This allows central control of the method to be achieved (centralized method). The assignment can be carried out by any of the missiles. In some examples, one of the missiles is instructed in this regard. Central control allows the search effort to be optimized.

According to one example, the at least two missiles each independently of one another stipulate the search subarea that is supposed to be searched by the radar of the missile. The independent assigning of the area to be searched by the respective missile achieves local control (decentralized method). The area to be searched, which the individual missile itself assigns, may be identical to the subarea if the search area is split into different search subareas by a missile on the basis of central control.

According to one aspect of the invention, there is provision for a missile that comprises at least one radar and a process unit. The process unit is configured to perform the method according to an aspect of the invention.

According to one aspect of the invention, there is provision for a missile formation that comprises at least two missiles, wherein the missile formation is configured to cover a search area in an airspace.

According to one aspect of the invention, the coordinated searching of a search area using at least two missiles, each of which has at least one radar arranged in it, is of great benefit. In particular, the method results in a time saving when searching a three-dimensional search area. If the search area is at arbitrarily prescribed angles of azimuth and elevation (horizontal and vertical angles) and the associated angle widths, then a simple split of the search area as in the prior art, for example halving of the search area, leads to significant time delays in the total search time. Such time delays are almost precluded in the case of the method according to an aspect of the invention. The search subareas do not overlap (minimal overlap of the search subareas, for example there may be a common boundary for the search subareas in some examples). The method splits the search area into the best possible subareas, so that the total search time needed for cooperatively searching the search area in order to ensure a desired probability of detection is minimal. In other words, the time needed in order to search a search area is minimized, with a minimal probability of detection for targets or objects of predetermined size at a predetermined distance being ensured. A timesaving for searching a three-dimensional volume that can be prescribed by the pilot is the result. In particular in the case of an arbitrarily prescribed search area, this leads to more effective and above all distinctly faster searching.

It should be pointed out that the features of the exemplary embodiments of the method also apply to embodiments of the missile and of the missile formation, and vice versa. Additionally, it is also possible to freely combine features for which this is not explicitly mentioned.

These and further aspects of the invention will become apparent by alluding and with reference to the embodiments that follow.

### BRIEF DESCRIPTION OF THE DRAWINGS

Exemplary embodiments of the invention are discussed more specifically below on the basis of the accompanying drawings, in which:

FIG. 1 shows two missiles and a search area in outline form;

FIG. 2 shows a search area to be searched in a coordinate system in exemplary fashion;

FIG. 3 shows a search area to be searched in a coordinate system in exemplary fashion;

FIG. 4 shows the split of the search area S1 from FIG. 2 into in each case two search subareas TS1, TS2;

FIG. 5 shows the split of the search area S2 from FIG. 3 into in each case two search subareas TS1, TS2;

FIG. 6 shows an example based on the prior art.

### DETAILED DESCRIPTION

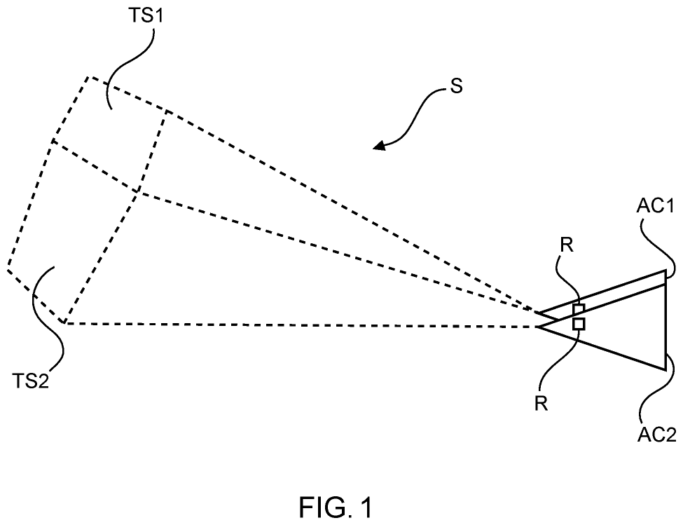

FIG. 1 shows two missiles AC1, AC2 and a search area S in outline form. The two missiles AC1, AC2 are in the air. Each missile AC1, AC2 has a radar R. The search area S is a three-dimensional area that is in the surroundings of the missiles AC1, AC2. The missiles AC1, AC2 fly as a flight formation in some exemplary embodiments.

The search area S is split into two search subareas TS1, TS2 that are searched by the radar R of the respective missile AC1, AC2. The search subareas TS1, TS2 have no overlap. The searching of the subareas TS1, TS2 is carried out cooperatively. As described in the figures that follow, the search subareas TS1, TS2 comprise the whole search area S.

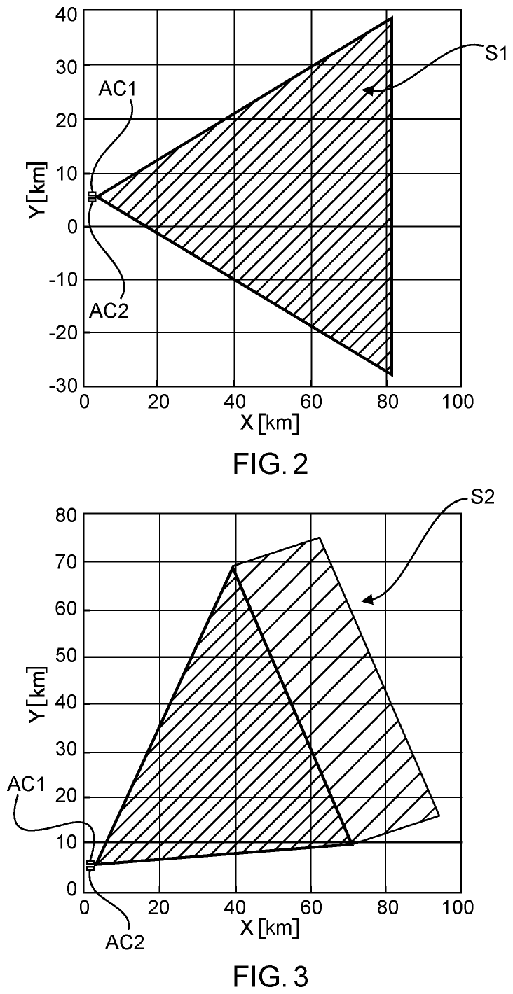

FIGS. 2 and 3 each show a search area S1 or S2. The missiles AC1, AC2 fly at an altitude of 10 km and are 500 m away from one another on the Y axis shown. For reasons of depictability, the missiles AC1, AC2 are barely distinguishable from one another. The numerical statements are exemplary. In what follows, the search area or the search subareas is/are specified by means of angle azimuth θ (horizontal angle) and an angle of elevation φ (vertical angle) and angle half-width θ-S1, θ-S2 for the angle of azimuth and φ-S1, φ-S2 for the angle of elevation.

In FIG. 2, the search area S1 is supposed to be searched by the respective radar R of the missiles AC1, AC2, said radar being centred at angle of azimuth θ=0° and angle of elevation φ=0°, that is to say directly in front of the missiles AC1, AC2, at an angle width θ-S1 of from −25° to 25° of the angle of azimuth and φ-S1 from −25° to 25° for the angle of elevation. Such a search area is usual to avoid collisions with other missiles.

In FIG. 3, the search area S2 is supposed to be searched by the respective radar R of the missiles AC1, AC2, said radar being centred at angle of azimuth θ=30° and angle of elevation φ=20°, at an angle width θ-S1 of from 5° to 55° of the angle of azimuth and φ-S1 from −5° to 45° for the angle of elevation. Such a search area represents a situation in which the pilots have been informed that possibly threatening targets or objects are approaching. In the case of unmanned missiles, an applicable device or system of the missiles receives the information. In other embodiments, it is possible for a ground station to receive the information.

In the two FIGS. 2 and 3, the search area S1, S2 is supposed to be searched as quickly as possible, for a given radar cross section σ and range, with a particular probability of detection PD being prescribed. According to the method, the search area S1 or S2 is split into two search subareas that are searched cooperatively by the respective radar R of the two missiles AC1, AC2. The search subareas in this case have no overlap.

A split for the search area S1, S2 is thus supposed to be found, so that a total search time for searching the search area S1, S2 is minimal. A probability of detection PD is supposed to be fulfilled in this case. In some exemplary embodiments, a minimal probability of detection for detecting a target or object of prescribed size and distance is ensured.

The method of splitting the search area S1 or S2 is performed for different combinations of in each case two search subareas TS1, TS2, and the total search time for searching the search area S1 or S2 is ascertained. In order to obtain the best split for the search area S1, S2, in each case the angle of azimuth range or the angle of elevation range is altered in this example. Each missile AC1, AC2 searches the whole elevation range but only part of the azimuth range, or the whole azimuth range but only part of the elevation range. In other examples, another combination can also be taken as a basis for the split.

For each combination, the radar illumination time per radar beam is ascertained. All the radar illumination times per missile AC1, AC2 are then summed. The total search time for a search area S1, S2 is calculated as the maximum from the search times for the applicable search subareas TS1, TS2.

The combination of the two search subareas TS1, TS2 having the shortest total search time is used for the searching of the search area S1 or S2 that then follows. In this example, the geometric split found based on a horizontal angle, vertical angle and a distance, the probability of detection PD for an object or target and the minimum total search time lead to fast searching of the search area S1 or S2 and hence to fast position image recognition. By way of example, an imminent risk of collision can be avoided.

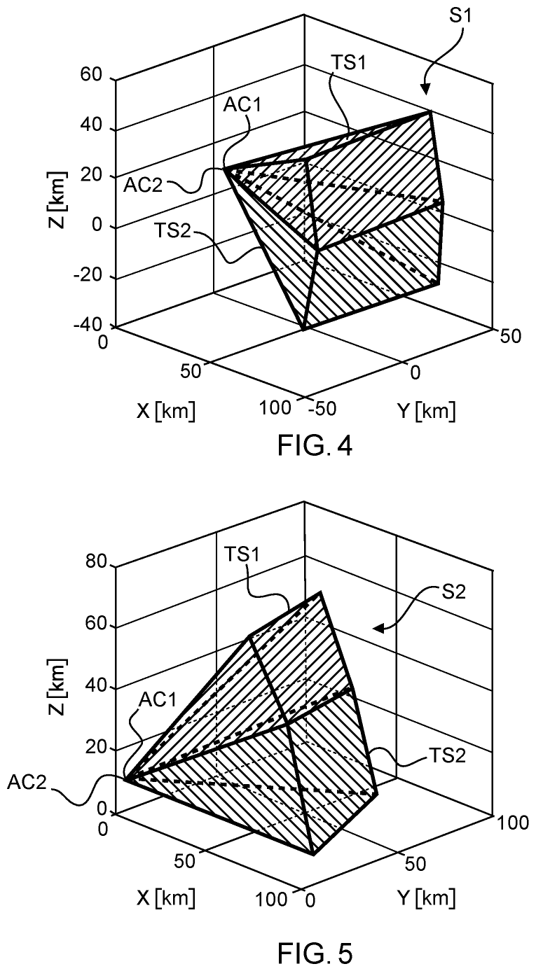

FIGS. 4 and 5 show the split of the search area S1, S2 from FIGS. 2, 3 into in each case the two search subareas TS1, TS2. Each search subarea TS1, TS2 is associated with one of the missiles AC1, AC2 and is searched by the radar R of the respective missile AC1, AC2.

FIG. 4 reveals symmetrical split into the search subareas TS1, TS2. Such a split is intuitive and simple. The split ratio for the elevation is 25°/25° for the search subareas TS1, TS2. The search area S1 is as described in FIG. 2.

FIG. 5 reveals a split into the search subareas TS1, TS2. The split ratio for the elevation is 27.8°/22.2° for the search subareas TS1, TS2. The search area S2 is as described in FIG. 3.

The figures show that when a search area is symmetrically around the antenna normal of the radar sensor (cf. FIG. 2), a symmetrical split for the search subareas TS1, TS2 leads to a minimal total search time. If, by contrast, the search area is not symmetrical, then a symmetrical split leads to a longer total search time, which means that significant time delays can be expected when searching the search area.

The time for forming the method in order to find the best split for the respective search area is much faster than searching the search area, which means that this hardly influences the total search time.

In a further example, the splitting of the search area S1, S2 into the two search subareas TS1, TS2 changes with the movement or the trajectory of the missile. In some examples, the split into the search subareas TS1, TS2 is continuously adapted.

In some embodiments, the method is performed in an appropriate apparatus for example of the missile AC1. This requires only the position of the other missile AC2 (cf. also FIG. 1). Said missile then assigns the search subarea to be searched TS2 to the other missile AC2. By way of example, only the following values are transmitted to the other missile AC2: azimuth and elevation centre line and the half-width of the search subarea TS2 assigned to the other missile AC2. This achieves central control of the method.

However, it is also possible for the missiles AC1, AC2 to each independently of one another stipulate the search subarea TS1, TS2 that is supposed to be searched by the radar R of the missile AC1, AC2. The independent assigning of the search subarea to be searched TS1, TS2 by the respective missile AC1, AC2 achieves local control.

The missiles AC1, AC2 described are equipped as appropriate for performing the method for searching the search area. By way of example, such a missile also has a process unit for performing the method.

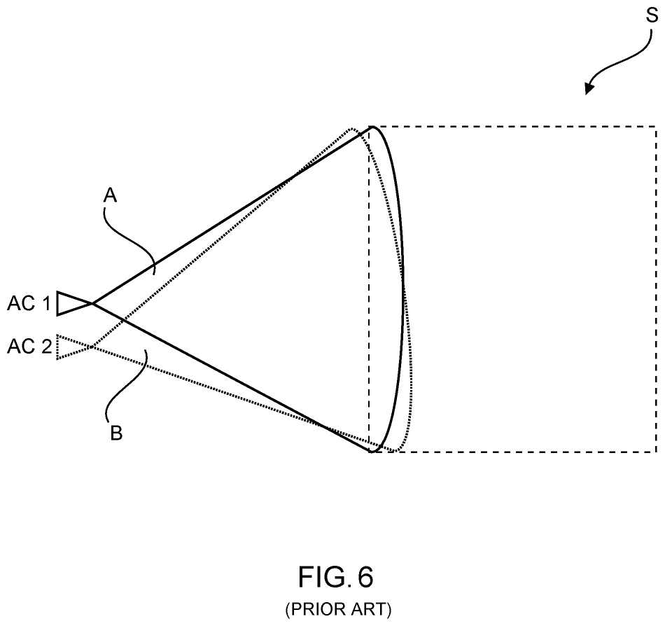

FIG. 6 shows the searching of an area S in an airspace based on the prior art. The search is carried out noncooperatively. In particular, the areas A, B searched by the respective missile AC1, AC2 are split such that these areas A, B largely overlap, as shown in FIG. 6. This extends the total search time and leads to time delays for the position image recognition.

The exemplary embodiments described above can be combined in different ways. In particular, aspects of the method can also be used for embodiments of the apparatuses and use of the apparatuses, and vice versa. The depictions in the figures are schematic and not to scale. Where the same reference signs are used in different figures in the description of the figures that follows, these denote identical or similar elements. Identical or similar elements may also be denoted by different reference signs, however.

Additionally, it should be pointed that out “comprising” does not preclude other elements or steps, and “a” or “one” does not preclude a multiplicity. Furthermore, it should be pointed out that features or steps that have been described and referenced to one of the exemplary embodiments above can also be used in combination with other features or steps of other exemplary embodiments described above. Reference signs in the claims are not intended to be regarded as restrictive.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for searching a search area, wherein in each case at least one radar is arranged in at least two missiles, the method comprising:
a) splitting the search area into at least two search subareas,
b) searching the at least two search subareas by the respective radar of the at least two missiles, wherein the at least two missiles carry out the searching cooperatively,
wherein the search subareas are chosen such that a total search time is minimal.

2. The method according to claim 1, wherein the total search time is the maximum from the search times for the applicable search subareas.

3. The method according to claim 1, wherein the probability of detection of an object in the search area is prescribable or predefined.

4. The method according to claim 1, wherein the search subareas have substantially no overlap.

5. The method according to claim 1, wherein the search area is prescribable or alterable.

6. The method according to claim 1, wherein the splitting of the search area into search subareas changes according to the movement and/or the trajectory of the at least two missiles.

7. The method according to claim 1, wherein the splitting of the search area into search subareas is continually adapted according to the movement and/or the trajectory of the at least two missiles.

8. The method according to claim 1, wherein a minimal probability of detection of an object of prescribed size at a prescribed distance is ensured.

9. The method according to claim 1, wherein a search subarea is determined based on a horizontal angle, a vertical angle and associated angle widths, or based on three-dimensional coordinates.

10. The method according to claim 1, wherein one of the at least two missiles assigns the search subarea to be searched to the at least one other missile.

11. The method according to claim 1, wherein the at least two missiles each independently of one another stipulate the search subarea that is supposed to be searched by the radar of the missile.

12. A missile, comprising at least one radar and a process unit, wherein the process unit is configured to perform a method according to claim 1.

13. A missile formation comprising at least two missiles according to claim 12, wherein the missile formation is configured to cover a search area in an airspace.
